(19) United States
(12) Patent Application Publication
(10) Pub. No.: US 2016/0057838 A1
(43) Pub. Date: Feb. 25, 2016

(54) EXTENSION INTERFACE FOR LUMINAIRES

(71) Applicant: GENERAL ELECTRIC COMPANY, Schenectady, NY (US)

(72) Inventors: István MAROS, BudaPest (HU); Tamás BOTH, BudaPest (HU); Roland BÁTAI, BudaPest (HU); András KUTI, BudaPest (HU); Péter SCHWARCZ, BudaPest (HU)

(21) Appl. No.: 14/809,182

(22) Filed: Jul. 25, 2015

Related U.S. Application Data
(60) Provisional application No. 62/041,359, filed on Aug. 25, 2014.

(51) Int. Cl. H05B 37/02; H01F 38/14

(52) U.S. Cl. CPC H05B 37/0272; H01F 38/14; H05B 37/0254

(57) ABSTRACT

An extension interface for integrating a modular extension unit into a luminaire includes a mounting for the modular extension unit, a power interface for providing power to the modular extension unit, and a communication interface for exchanging commands and data between the modular extension unit and a controller of the luminaire. A method of integrating a modular extension unit into a luminaire includes mounting the modular extension unit onto the luminaire, providing power to the modular extension unit via a power interface, and exchanging commands and data between the modular extension unit and a controller of the luminaire using a communication interface. A luminaire includes a light source, power circuitry for providing power to the light source, control circuitry for controlling the light source and the power circuitry, and an extension interface for integrating a modular extension unit into the luminaire.

### PRIORITY

This application claims benefit of and priority to U.S. Provisional Patent Application 62/041,359, filed 25 Aug. 2014, which is hereby incorporated by reference.

### FIELD

The disclosed exemplary embodiments relate generally to lighting equipment, and more particularly to a modularly constructed luminaire.

### BACKGROUND

A luminaire typically includes one or more light sources or lamps, light distribution devices, and connections to a power supply. Other components may include devices to position the light sources and to cover or otherwise protect the components, for example from the environment. A luminaire may also include drivers, sensors, actuators and circuitry that may provide functionality in addition to simply providing light. For example, luminaire manufacturers may place cameras, motion sensors, radio frequency identification (RFID) systems, data collection devices, closed circuit television cameras, and other equipment in the luminaire body. In some instances, the equipment is placed in luminaire type bodies for concealment and aesthetic reasons. The deployment of the additional functionality typically requires wiring the additional equipment to the power supply of the luminaire or providing battery power. Additional wiring or other circuitry may also be required for data communication functions. Installation of the additional functionality is typically expensive and labor intensive, may result in additional infrastructure requirements such as additional wiring and power resources, and may also result in increased maintenance costs. Furthermore, the different functions may have different physical mounting and enclosure requirements.

It would be desirable to provide a luminaire that addresses the problems identified above.

### SUMMARY

As described herein, the exemplary embodiments overcome one or more of the above or other disadvantages known in the art.

The exemplary embodiments are directed to an extension interface for integrating a modular extension unit into a luminaire including a mounting for the modular extension unit, a power interface for providing power to the modular extension unit, and a communication interface for exchanging commands and data between the modular extension unit and a controller of the luminaire.

The mounting may include a receptacle that at least partially encloses the modular extension unit.

The power and communication interfaces may include contact plates for conducting power and data signals between the modular extension unit and the extension interface.

The power interface may include a non-contact wireless power interface.

The non-contact wireless power interface may include a power transmitter coil comprising a part of a transformer when positioned proximate a corresponding coil in the modular extension unit.

The communication interface may include power circuitry configured to superimpose a communication signal on an alternating signal applied to the non-contact wireless power interface for providing commands and data to the modular extension unit.

The communication interface may include a non-contact wireless communication interface.

The non-contact wireless communication interface may include an optical interface.

The non-contact wireless communication interface may include a radio frequency interface.

The extension interface may further include a plurality of mountings for a plurality of modular extension units, a plurality of power interfaces for providing power to the plurality of modular extension units, and a bus connecting a plurality of communication interfaces connected to the plurality of modular extension units, the bus further connected to a controller of the luminaire for exchanging commands and data between the plurality of modular extension units and the controller.

The exemplary embodiments are also directed to a method of integrating a modular extension unit into a luminaire including mounting the modular extension unit onto the luminaire, providing power to the modular extension unit via a power interface, and exchanging commands and data between the modular extension unit and a controller of the luminaire using a communication interface.

The method may include mounting the modular extension unit by at least partially enclosing the modular extension unit within a receptacle.

The power and communication interfaces may include contact plates for conducting power and data signals between the modular extension unit and the extension interface.

The power interface may include a non-contact wireless power interface.

The method may include providing power to the modular extension unit by applying an alternating signal to a power transmitter coil positioned proximate a corresponding coil in the modular extension unit.

The method may include exchanging commands and data between the modular extension unit and the controller by superimposing a communication signal on an alternating signal applied to the non-contact wireless power interface.

The method may include exchanging commands and data between the modular extension unit and the controller using a non-contact wireless communication interface.

The method may include exchanging commands and data between the modular extension unit and the controller using an optical communication interface

The method may include exchanging commands and data between the modular extension unit and the controller using a radio frequency communication interface.

The method may further include mounting a plurality of modular extension units onto the luminaire, providing power to the plurality of modular extension units via a plurality of power interfaces, and exchanging commands and data between the plurality of modular extension units and a controller of the luminaire through a bus connected to a plurality of communication interfaces and connected to the controller.

The exemplary embodiments are also directed to a luminaire including a light source, power circuitry for providing power to the light source, control circuitry for controlling the light source and the power circuitry, and an extension interface for integrating a modular extension unit into the luminaire. The extension interface includes a mounting for the modular extension unit, a power interface for providing power to the modular extension unit, and a communication interface for exchanging commands and data between the modular extension unit and the control circuitry of the luminaire.

The luminaire may include a modular extension unit integrated with the luminaire.

The mounting may include a receptacle that at least partially encloses the modular extension unit.

The power and communication interfaces may include contact plates for conducting power and data signals between the modular extension unit and the extension interface.

The power interface may include a non-contact wireless power interface.

The non-contact wireless power interface may include a power transmitter coil comprising a part of a transformer when positioned proximate a corresponding coil in the modular extension unit.

The communication interface may include power circuitry configured to superimpose a communication signal on an alternating signal applied to the non-contact wireless power interface for providing commands and data to the modular extension unit.

The communication interface may include a non-contact wireless communication interface.

The non-contact wireless communication interface may include an optical interface.

The non-contact wireless communication interface may include a radio frequency interface.

The luminaire may further include a plurality of mountings for a plurality of modular extension units, a plurality of power interfaces for providing power to the plurality of modular extension units, and a bus connecting a plurality of communication interfaces and for connection to the plurality of modular extension units, the bus further connected to the control circuitry of the luminaire for exchanging commands and data between the plurality of modular extension units and the control circuitry.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 shows an exemplary luminaire for implementing the disclosed embodiments;

FIG. 2 shows a block diagram of an exemplary lighting fixture;

FIG. 3 shows a schematic illustration of a light source, lighting fixture driver and an extension interface;

FIG. 4 shows a schematic diagram of an implementation of a mechanism for activating a modular extension unit;

FIGS. 5A and 5B show diagrams of exemplary embodiments of an extension interface;

FIG. 6 shows a block diagram of another embodiment of an extension interface;

FIG. 7 shows a block diagram of a further embodiment of an extension interface;

FIG. 8 shows a block diagram of yet another embodiment of an extension interface;

FIG. 9 shows a block diagram of still another embodiment of the extension interface;

FIG. 10 shows a block diagram of an embodiment of an extension interface that provides an interface to more than one modular extension unit; and

FIG. 11 shows a block diagram of another embodiment of an extension interface that interfaces with more than one modular extension unit.

### DETAILED DESCRIPTION

The disclosed embodiments are directed to a method and interface for integrating modularly installable and interchangeable functional extension units into a luminaire. When designing a product which uses this method for integrating functions, the design process can be divided into designing a base unit lighting fixture with the disclosed interface and designing one or more functional modular extension units. The base lighting fixture may be functional alone by itself with a base feature set, and upon connection of one or more modular extension units via the hereby described interface, functions within the one or more modular extension units become active as additional features of the base lighting fixture. The modular extension units may be removable and may be interchangeable with other modular extension units. In some embodiments, the luminaire may accommodate more than one modular extension units allowing multiple and varied functions to be incorporated into the luminaire.

The disclosed embodiments make it possible to create a range of luminaires with different additional functions, without the need for designing and manufacturing a whole new luminaire for each functional requirement. For example, the base luminaire may be designed and manufactured as one product, with the modular extension units as other, distinct products. After the separate design and manufacturing processes, one or more modular extension units may be snapped into or otherwise attached to the base luminaire and the various assemblies may be offered as different products. A unified mechanical and electrical interface between the luminaire and the modular extension units ensures compatibility and provides additional functionality without further structural requirements. The disclosed embodiments provide a selection of various functions for each lighting fixture, before and after installation, and as many times as desired. By using a common form factor and interface, the modular extension units can be installed and exchanged as required, and a large number of different stock keeping units may be generated while manufacturing just a few components. Luminaire functionality may be modified by changing or adding modular extension units.

The disclosed embodiments make it possible to use the luminaire as an infrastructure to host various intelligent devices (lighting or non-lighting related), and may reduce installation time and cost, and make an extension upgrade fast and safe. The extension interface embodiments may provide an open architecture for other 3rd party modular extension units.

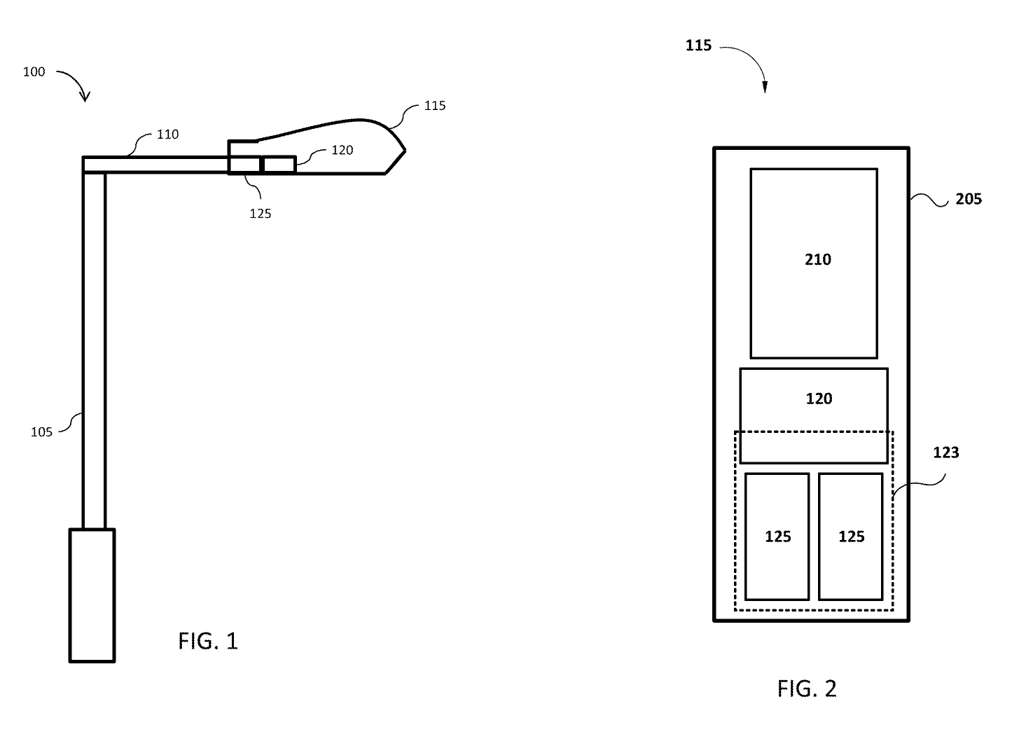

FIG. 1 shows an exemplary luminaire 100 for implementing the disclosed embodiments. The exemplary luminaire may include a pole 105, a pole arm 110, a lighting fixture 115, a lighting fixture driver 120 and one or more modular extension units 125.

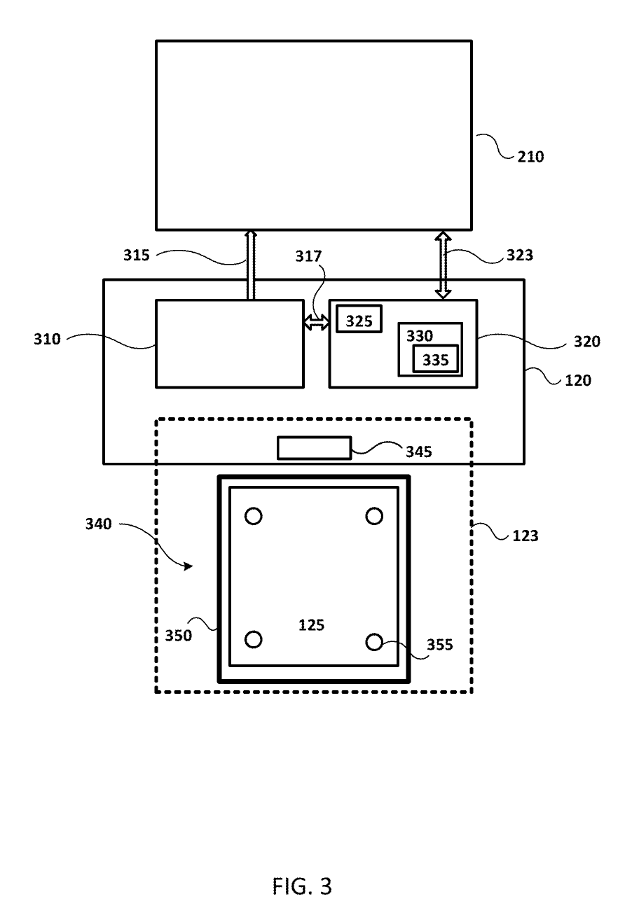

FIG. 2 shows a block diagram of the exemplary lighting fixture 115 in FIG. 1. The exemplary lighting fixture may include a housing 205, a light source 210, the lighting fixture driver 120 and an extension interface 123 to one or more modular extension units 125. The extension interface 123 generally includes a mechanism for activating and optionally retaining at least one modular extension unit 125.

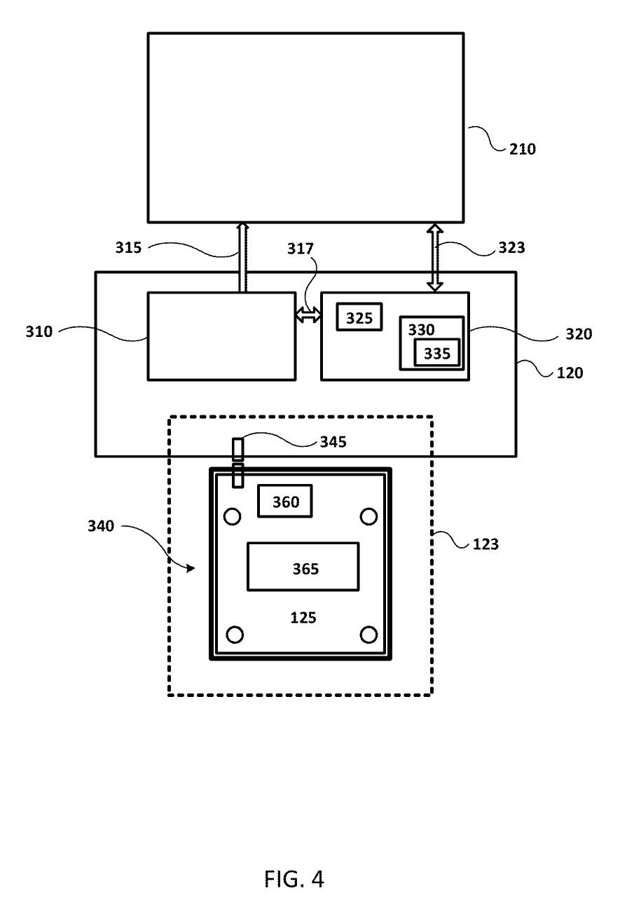

FIG. 3 shows a schematic illustration of the light source 210, lighting fixture driver 120 and an embodiment of the extension interface 123. The light source may include one or more sources of illumination of various types including, for example, incandescent, electron stimulated, electroluminescent, or gas discharge. It should be understood that any suitable source of illumination may be utilized. In at least one embodiment, the light source 210 may include one or more Light Emitting Diodes (LEDs).

The lighting fixture driver 120 may include power circuitry 310 for providing power and control circuitry 320 for exchanging control signals with the light source 210, the power circuitry 310 and other circuitry of the lighting fixture 115. The lighting fixture driver 120 may receive power from an alternating current (AC) power mains distribution system, a direct current power source, or other external power source, or may have an on board power source, for example, one or more of a battery, a solar array, or other power source.

The power circuitry 310 may include voltage, current, or power conversion circuitry, filters, conditioning circuitry, and an output 315 for providing power to the light source 210.

The control circuitry 320 may generally include a controller 325 and a memory 330 with program code 335, that when executed by the controller 325, enables the controller 325 to exchange signals 317 with the power circuitry 310 to control the power circuitry and to exchange signals 323 with the light source 210 to determine, for example, brightness, power consumption, or other characteristics of the light source. The control circuitry 320 may also utilize the signals 323 from the light source 210 for controlling the power circuitry 310.

The extension interface 123 includes a mechanism 345 for activating the modular extension unit 125, and optionally, a mounting 340 for retaining or holding the modular extension unit 125. In at least one embodiment, the mounting 340 for retaining or holding the modular extension unit 125 includes a receptacle 350 that at least partially receives or encloses a portion of the modular extension unit 125. In at least one aspect, the receptacle 350 may provide a snap fit with the modular extension unit 125 for attaching the modular extension unit to the lighting fixture 115. In other aspects, one or more fasteners 355 may be used to attach the modular extension unit 125 to the lighting fixture 115. It should be understood that the extension interface 123 may include any suitable attachment mechanism or technique for coupling the modular extension unit 125 to the lighting fixture 115. The extension interface 123 may be sized to accommodate a single modular extension unit or optionally may be sized to accommodate a number of modular extension units. In at least one embodiment, multiple modular extension units may have dimensions that facilitate interchangeability.

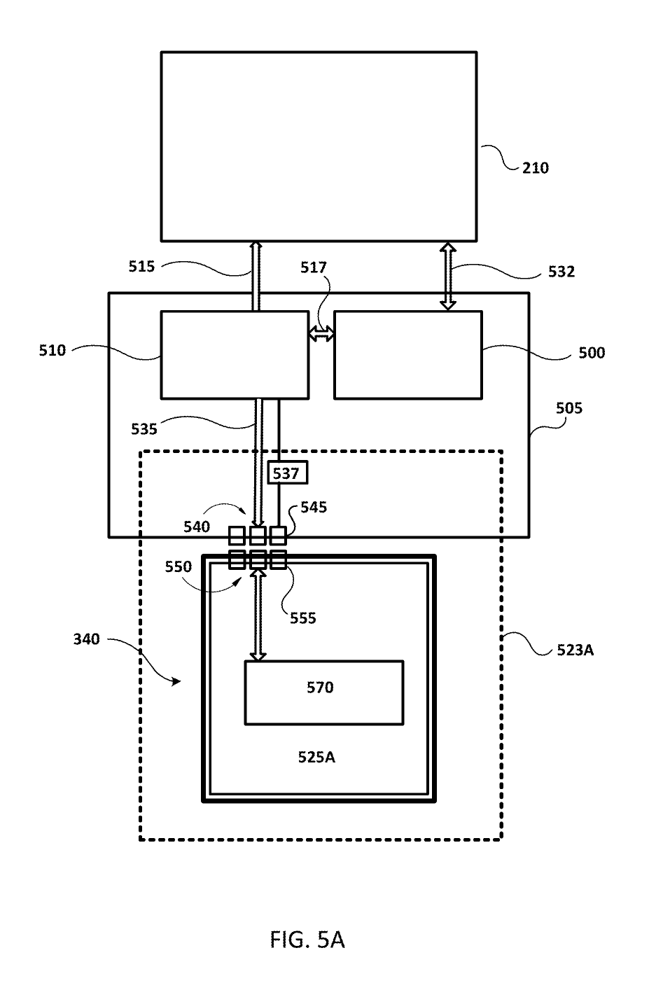

FIG. 4 shows a schematic diagram of one implementation of the mechanism 345 for activating the modular extension unit 125. In at least one embodiment, the activation mechanism 345 operates to switch an internal power supply 360 of the modular extension unit 125 on, upon attachment of the modular extension unit 125 to the lighting fixture 115, and off upon detachment. The switching may be accomplished with a mechanical pushbutton, a magnetically activated reed switch, or any other suitable mechanism. The internal power supply 360 may include one or more batteries, solar arrays, or other self-contained power source that provides power to any number of devices and functions 365 of the modular extension unit 125.

The modular extension unit 125 may include any number of additional devices and functions 365. For example, the modular extension unit 125 may include one or more wireless remote dimmer units for the light fixture 115, monitoring units for maintenance and reporting and diagnosing problems with light fixture 115, temporary or permanent IEEE 802.11 or 802.16 wireless access points, cellular base stations, micro cells or other telecommunication devices, cameras, data acquisition devices, motion sensors, data collection functions, environmental parameter sensors, gas concentration sensors, sensor networks or any other suitable devices and functions. Applications may include determining road usage parameters, traffic density visualizations, and gas concentration maps. As another example, the disclosed embodiments may be used to provide temporary wi-fi access for the duration of an outdoor event by attaching wi-fi modular extension units to the lighting fixture.

While one modular extension unit 125 is illustrated, it should be understood that any number of modular extension units may be included in the lighting fixture 115.

In the embodiments illustrated herein, the extension interface 123 and the modular extension unit 125 may be enclosed by a non-permeable material, for example, molded plastic, and may provide resistance to corrosion, water, dust, and other invasive substances. The non-permeable enclosure may provide an enhanced ingress protection (IP) rating. In some embodiments the extension interface and the modular extension unit may be sealed, providing even further resistance to corrosion, water, dust, and other invasive substances.

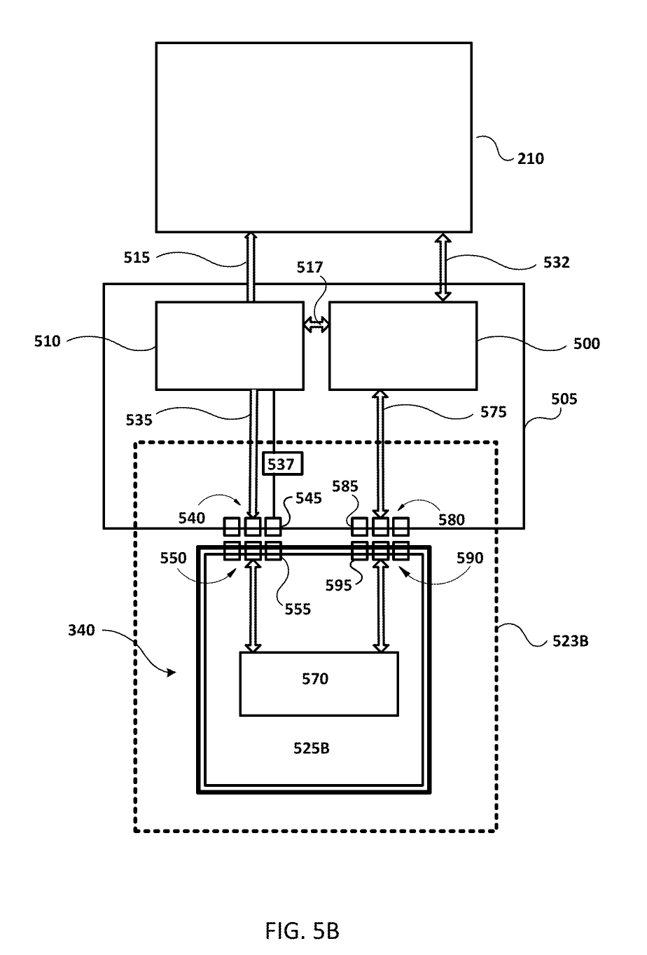

FIG. 5A shows a diagram of an exemplary embodiment of the extension interface 523A. The lighting fixture driver 505 may include power circuitry 510 and control circuitry 500 similar to power circuitry 310 and control circuitry 320 and may receive power or include a power source in a manner similar to lighting fixture driver 120.

The power circuitry 510 may include voltage, current, or power conversion circuitry, filters, and other conditioning circuitry. The power circuitry may also include an output 515 for providing power to the light source 210 and an output 535 for providing power to the modular extension unit 525A.

The control circuitry 500 operates to exchange signals 517 with the power circuitry 510 for controlling the power circuitry and to exchange signals 532 with the light source 210 to determine, for example, brightness, power consumption, or other characteristics of the light source 210. The control circuitry 500 may utilize the signals 532 from the light source 210 for controlling the power circuitry 510.

The extension interface 523A may include a power interface 540 for providing power to the modular extension unit 525A from the power output 535. In this embodiment, the power interface 540 includes one or more contact plates 545. The contact plates 545 generally include conductors that provide power connections between the power circuitry 510 and the modular extension unit 525A. The extension interface 523A may also include a sensor 537 for detecting the presence of the modular extension unit 525A and providing a signal to the power circuitry 510 for enabling the output 535 when the modular extension unit 525A is present or disabling the output 535 in the absence of the modular extension unit 525A.

The modular extension unit 525A may include a corresponding power interface 550 for receiving power from the power interface 540 of the extension interface 523A. The modular extension unit power interface 550 includes contact plates 555 for conducting power from the conditioning circuitry contact plates 545 for use within the modular extension unit 525A. The modular extension unit power interface 550 may be positioned to mate with power interface 540 upon an attachment of the modular extension unit 525A to the lighting fixture 115. The contact plates 555 generally provide power to devices and functions 570 within the modular extension unit 525A, which may be similar to the devices and functions 365 of the modular extension unit 125.

FIG. 5B shows a diagram of another embodiment of the extension interface 523B. In this embodiment, the control circuitry 520 may also include a communication path 575 for exchanging communications with the modular extension unit 525B. Accordingly, the extension interface 523B may also include a communication interface 580 for exchanging communications with the control circuitry 500 over the communication path 575. In one exemplary embodiment, the communication interface 580 includes one or more contact plates 585. The contact plates 585 generally provide conductors for signals between the control circuitry 500 and the modular extension unit 525B. The control circuitry 500 may utilize communication signals exchanged with the modular extension unit 525B for controlling the power circuitry 510 and the light source 210 and for providing other functions within the lighting fixture 115.

The modular extension unit 525B may further include a communication interface 590 for exchanging communications with the control circuitry 500 over the communication interface 580. The modular extension unit communication interface 590 includes contact plates 595 for conducting signals between the modular extension unit 525B and the contact plates 585. The modular extension unit communication interface 590 may be positioned to mate with the communication interface 580 of the lighting fixture driver 505 upon an attachment of the modular extension unit 525B to the lighting fixture 115.

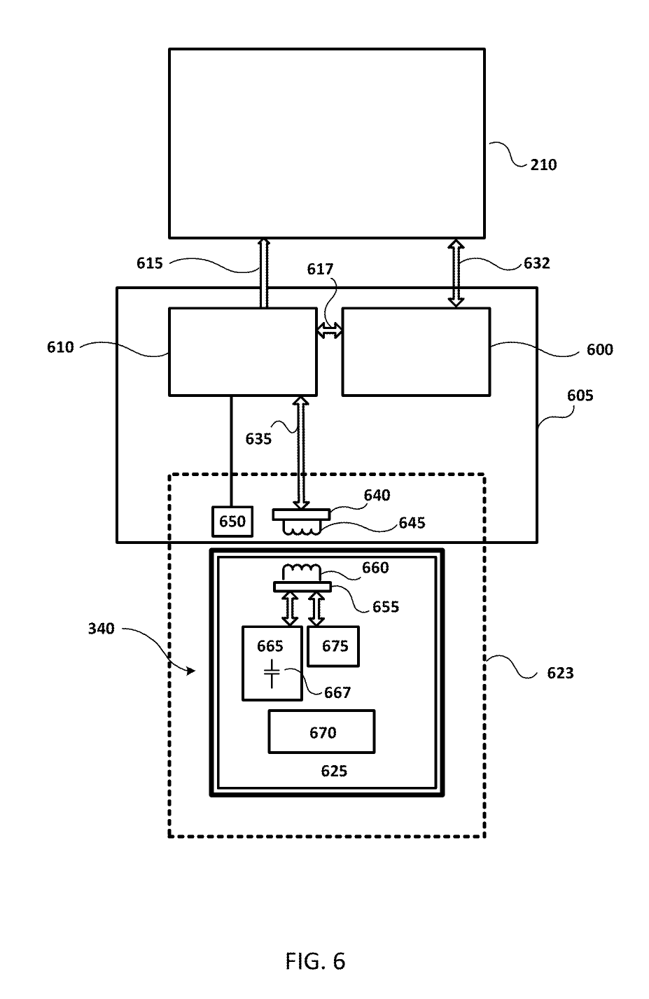

FIG. 6 shows a block diagram of yet another embodiment of the extension interface 623. The lighting fixture driver 605 may include power circuitry 610 and control circuitry 600 similar to power circuitry 310 and control circuitry 320 and may receive power or include a power source in a manner similar to lighting fixture driver 120. The power circuitry 610 may include an output 615 for providing power to the light source 210 and an output 635 for providing power to the modular extension unit 625. The control circuitry 600 exchanges signals 617 with the power circuitry 610 and signals 632 with the light source 210.

In accordance with the disclosed embodiments, the extension interface 623 includes a non-contact wireless power interface 640 for providing power to the modular extension unit 625 from the power output 625. The power interface 640 includes an inductive charging or wireless charging mechanism that operates, for example, by applying an alternating signal to a power transmitter coil 645. The power transmitter coil 645 may include a stand-alone air core or an air gapped ferrite core, and operates as part of a transformer when positioned proximate a corresponding coil in the modular extension unit 625.

In some embodiments, the power interface 640 may utilize the operating principles of switch-mode power supplies, and the power transmitting coil 645 may be implemented with printed circuit board coils having only a few turns, with applied signals having a switching frequency in the range of approximately 1-10 Megahertz.

The extension interface 623 may also include a sensor 650 for detecting the presence of the modular extension unit 625 and providing a signal to the power circuitry 610 for enabling the output 635 when a modular extension unit is present or disabling the output 635 when no modular extension unit is present.

In this embodiment, the power interface 640 also includes a communication interface to provide unidirectional or bidirectional communication with the modular extension unit 625. In an exemplary embodiment, the communication interface may include the power circuitry 610 which receives communication signals from the control circuitry 600 to modulate the power delivered to the power interface 640, for example, by superimposing a communication signal on the alternating signal applied to the power interface 640. Alternately, the communication signal may be coded into pulses used to interrupt the alternating signal applied to the power interface 640, where the interruptions are detected as pulses and decoded by receiving circuitry in the modular extension unit 625. Corresponding modulation originating from the modular extension unit 625 may be received through the power interface 640 and detected by circuitry in the lighting fixture driver 605.

The modular extension unit 625 also includes a power interface 655 for receiving power from the lighting fixture driver power interface 640. The power interface 655 includes an inductive charging power receiver coil 660 for receiving the alternating signal through the transformer formed by the power transmitter coil 645 and the power receiver coil 660. Similar to the power transmitter coil, the power receiver coil 660 may include a stand-alone air core or an air gapped ferrite core. The modular extension unit 625 may include conditioning circuitry 665, for example, voltage, current, or power conversion circuitry, filters, and other conditioning circuitry, suitable for conditioning the received power for use by the devices and functions 670 within the modular extension unit 625.

The power interface 655 of the modular extension unit 625 may also include a communication facility 675 to provide unidirectional or bidirectional communication with the lighting fixture driver 605. The communication facility 675 generally includes circuitry for demodulating the received alternating signal to detect superimposed communication signals, or for detecting interruptions in the received alternating signal as pulses and decoding the pulses into received communication signals. The communication facility 675 may also include circuitry for applying signals to the power interface 655 to send communications to the lighting fixture driver 605. In an embodiment where interruptions in the received alternating signal are used for communication, the conditioning circuitry 665 may include a buffer capacitor 667 for storing the operating power.

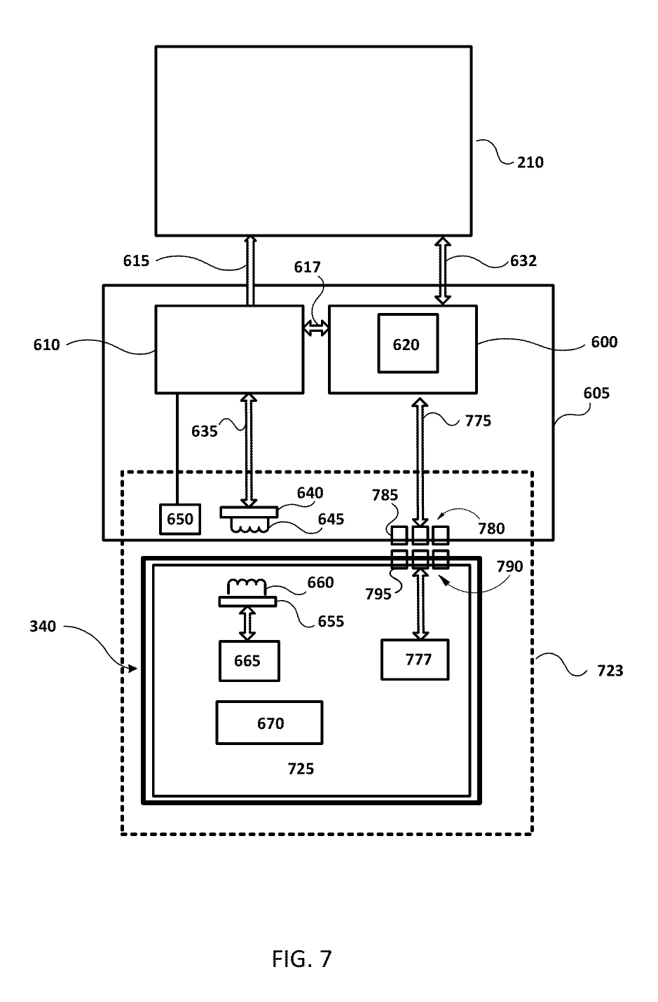

FIG. 7 shows a block diagram of an embodiment of the extension interface 723 having a non-contact wireless power interface 640 and a communication interface 780 separate from the power interface 640. In this embodiment, the communication interface 780 includes one or more contact plates 785 comprising conductors for conducting communication signals 775 between the lighting fixture driver 605 and the modular extension unit 725.

The modular extension unit 725 may include a separate communication facility 777 connected to the communication interface 790 to provide unidirectional or bidirectional communication with the lighting fixture driver 605. The communication facility 777 generally includes circuitry for exchanging communication signals with the control circuitry 600 through the communication interfaces 780, 790. The modular extension unit communication interface 790 may be positioned to mate with the communication interface 780 of the lighting fixture driver 605 upon an attachment of the modular extension unit 725 to the lighting fixture 115.

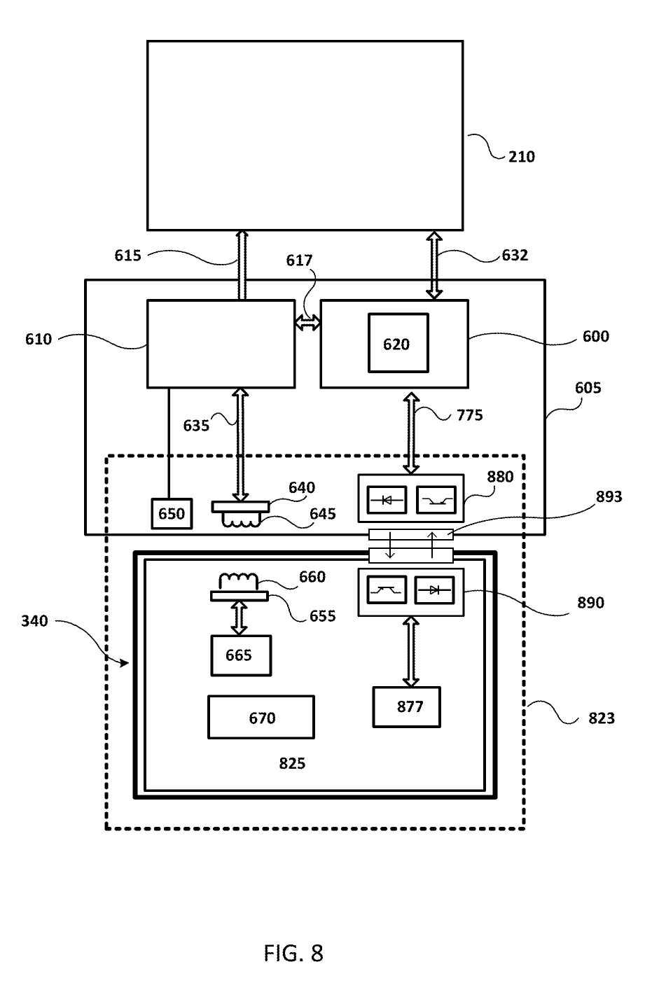

FIG. 8 shows a block diagram of an embodiment of the extension interface 823 including the non-contact wireless power interface 640 and a separate non-contact wireless communication interface 880. The communication interface 880 includes one or more optical transceivers for transmitting and receiving optical signals between the extension interface 823 and the modular extension unit 825. In some embodiments, the non-contact interface 880 may be unidirectional including an optical receiver or an optical transmitter. In other embodiments, the non-contact interface 880 may be bi-directional having both an optical transmitter and an optical receiver. The extension interface 823 may also include an optical port 893 that allows transmission of optical signals while maintaining a sealed environment for the lighting fixture driver 605.

The modular extension unit 825 may include a corresponding non-contact wireless communication interface 890. The communication interface 890 includes one or more optical transceivers for transmitting and receiving optical signals between the extension interface 823 and the modular extension unit 825. In some embodiments, the non-contact interface 880 may be unidirectional including an optical transmitter or receiver, corresponding respectively to an optical receiver or transmitter of the extension interface 823. In other embodiments, the non- contact interface 880 may be bi-directional having both an optical transmitter and an optical receiver.

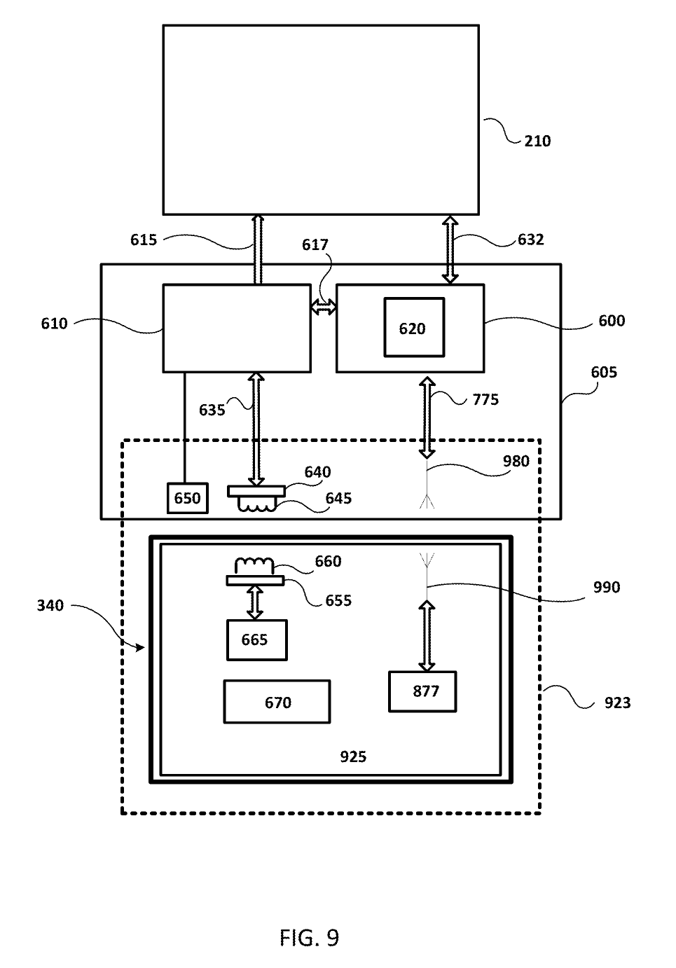

FIG. 9 shows a block diagram of an embodiment of the extension interface 923 including the non-contact wireless power interface 640, where the separate non-contact wireless communication interface 980 includes a Radio Frequency (RF) interface. The RF interface 980 includes one or more antenna for transmitting and receiving RF signals between the extension interface 923 and the modular extension unit 925. In some embodiments, the non-contact interface 980 may be implemented using Near Field Communication (NFC), Bluetooth®, IEEE 802.11 or 802.16, or any other suitable RF communication technique.

The modular extension unit 925 may include a corresponding RF communication interface 990 that may also include at least one antenna for transmitting and receiving RF signals between the extension interface 923 and the modular extension unit 925.

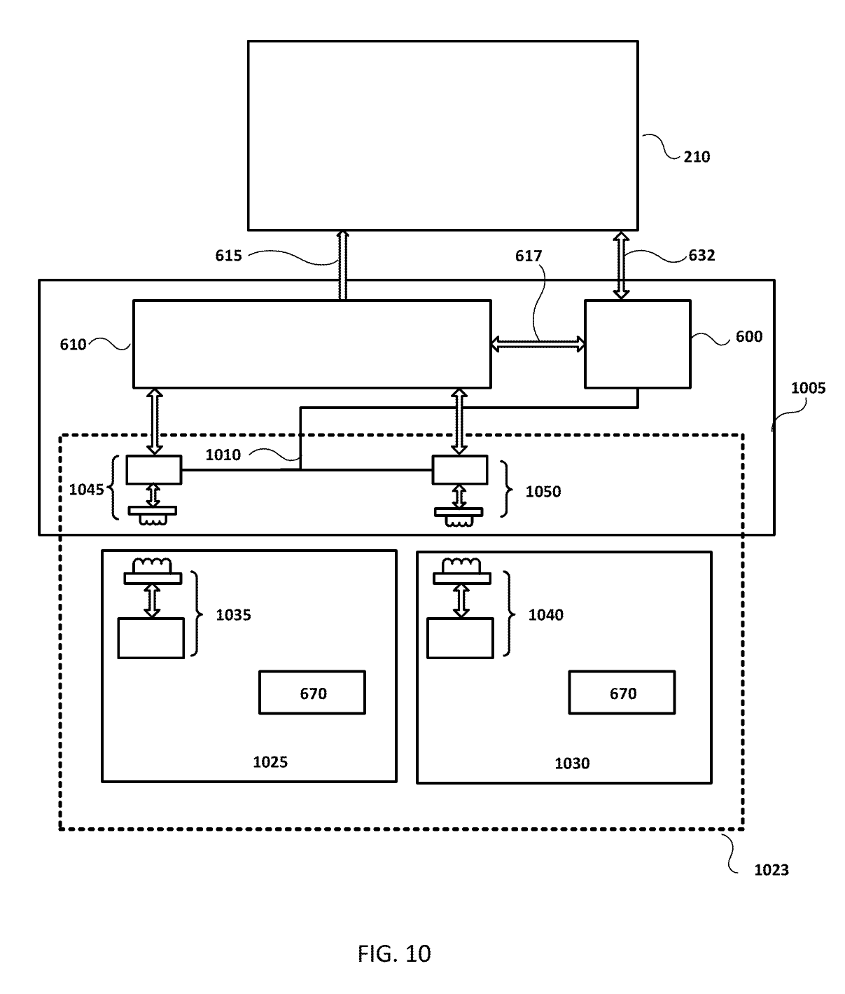

FIG. 10 shows a block diagram of an embodiment of the extension interface 1023 that provides an interface to more than one modular extension unit 1025, 1030. The modular extension units 1025, 1030 utilize communication signals superimposed on alternating power signals applied to their respective coil and power interfaces 1035, 1040 or communication signals coded into pulses used to interrupt the alternating signal applied to their respective coil and power interfaces 1035, 1040, as described above with respect to the embodiment of FIG. 6. A communication bus 1010 connects the corresponding coil and power interfaces 1045, 1050 of the lighting fixture driver 1005 together, along with the control circuitry 600 and provides a communication path for exchanging data. As a result, each device attached to the communication bus 1010 may exchange data and commands between themselves and with the control circuitry 600. The communication bus 1010 may be implemented using various physical embodiments including optical, RF, wired, or any suitable physical structure. A communication protocol may be implemented over the bus 1010, for example, a Digital Addressable Lighting Interface (DALI) protocol, a lightweight custom data transfer protocol, or any protocol suitable for providing communication facilities among the modular extension units 1025, 1030, and the lighting fixture driver 1005.

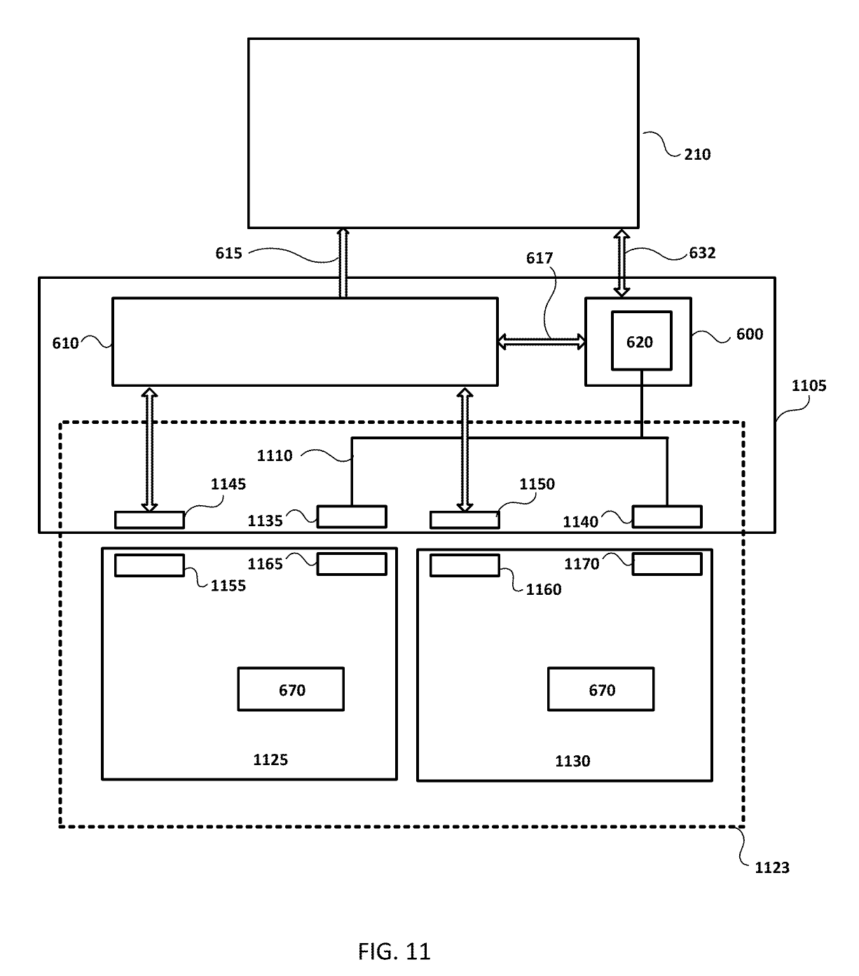

FIG. 11 shows a block diagram of an embodiment of the extension interface 1123 that interfaces with more than one modular extension unit 1125, 1130 where the communication interfaces 1135, 1140 are separate from the power interfaces 1145, 1150. The communication interfaces 1135, 1140 of the lighting fixture driver 1105 are connected together, along with the control circuitry 600 over communication bus 1110 that provides a communication path for exchanging data among the interfaces 1135, 1140 and the driver 1105. As a result, each device attached to the communication bus 1110 may exchange data and commands between themselves and with the control circuitry 600. One or more communication protocols may be implemented over the bus 1110, for example, a Digital Addressable Lighting Interface (DALI) protocol, a lightweight custom data transfer protocol, or any protocol suitable for providing communication facilities among the modular extension units 1125, 1130, and the lighting fixture driver 1105.

The extension interface power interfaces 1145, 1150 provide power to corresponding modular extension unit power interfaces 1155, 1160. The power interfaces 1145, 1150, 1155, 1160 may be implemented as one or more of contact power interfaces, for example, 540, 550 (FIG. 5B), non-contact power interfaces 640, 655 (FIG. 6), or any other suitable power interface. The extension interface communication interfaces 1135, 1140 exchange communications with corresponding modular extension unit communication interfaces 1165, 1170. The communication interfaces 1135, 1140, 1165, 1170 may be implemented as one or more of contact communication interfaces 580, 590 (FIG. 5B), non-contact communication interfaces 880, 890 (FIG. 8) or 980, 990 (FIG. 9), or any other suitable communication interface.

The disclosed embodiments provide a range of various modular functions that may be incorporated into one or more luminaires without requiring a redesign or modification to the luminaires. One or more modular extension units may be snapped into or otherwise attached to a luminaire to provide additional functionality without requiring additional structural changes. Luminaire functionality may be modified or enhanced simply by changing or adding modular extension units.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Furthermore, some of the features of the exemplary embodiments could be used to advantage without the corresponding use of other features. As such, the foregoing description should be considered as merely illustrative of the principles of the disclosed embodiments and not in limitation thereof.

1. An extension interface for integrating a modular extension unit into a luminaire comprising:
a mounting for the modular extension unit;
a power interface for providing power to the modular extension unit; and
a communication interface for exchanging commands and data between the modular extension unit and a controller of the luminaire.

2. The interface of claim 1, wherein the mounting comprises a receptacle that at least partially encloses the modular extension unit.

3. The interface of claim 1, wherein the power and communication interfaces comprise contact plates for conducting power and data signals between the modular extension unit and the extension interface.

4. The interface of claim 1, wherein the power interface comprises a non-contact wireless power interface.

5. The interface of claim 4, wherein the non-contact wireless power interface includes a power transmitter coil comprising a part of a transformer when positioned proximate a corresponding coil in the modular extension unit.

6. The interface of claim 4, wherein the communication interface comprises power circuitry configured to superimpose a communication signal on an alternating signal applied to the non-contact wireless power interface for providing commands and data to the modular extension unit.

7. The interface of claim 1, wherein the communication interface comprises a non-contact wireless communication interface.

8. The interface of claim 7, wherein the non-contact wireless communication interface comprises an optical interface.

9. The interface of claim 7, wherein the non-contact wireless communication interface comprises a radio frequency interface.

10. The extension interface of claim 1, comprising:
a plurality of mountings for a plurality of modular extension units;
a plurality of power interfaces for providing power to the plurality of modular extension units; and
a bus connecting a plurality of communication interfaces connected to the plurality of modular extension units, the bus further connected to a controller of the luminaire for exchanging commands and data between the plurality of modular extension units and the controller.

11. A method of integrating a modular extension unit into a luminaire comprising:
mounting the modular extension unit onto the luminaire;
providing power to the modular extension unit via a power interface; and
exchanging commands and data between the modular extension unit and a controller of the luminaire using a communication interface.

12. The method of claim 11, comprising mounting the modular extension unit by at least partially enclosing the modular extension unit within a receptacle.

13. The method of claim 11, wherein the power and communication interfaces comprise contact plates for conducting power and data signals between the modular extension unit and the extension interface.

14. The method of claim 11, wherein the power interface comprises a non-contact wireless power interface.

15. The method of claim 14, wherein providing power to the modular extension unit comprises applying an alternating signal to a power transmitter coil positioned proximate a corresponding coil in the modular extension unit.

16. The method of claim 14, comprising exchanging commands and data between the modular extension unit and the controller by superimposing a communication signal on an alternating signal applied to the non-contact wireless power interface.

17. The method of claim 11, comprising exchanging commands and data between the modular extension unit and the controller using a non-contact wireless communication interface.

18. The method of claim 11, comprising exchanging commands and data between the modular extension unit and the controller using an optical communication interface.

19. The method of claim 11, comprising exchanging commands and data between the modular extension unit and the controller using a radio frequency communication interface.

20. The method of claim 11, comprising:
mounting a plurality of modular extension units onto the luminaire;
providing power to the plurality of modular extension units via a plurality of power interfaces; and
exchanging commands and data between the plurality of modular extension units and a controller of the luminaire through a bus connected to a plurality of communication interfaces and connected to the controller.

21. A luminaire comprising:
a light source;
power circuitry for providing power to the light source;
control circuitry for controlling the light source and the power circuitry; and
an extension interface for integrating a modular extension unit into the luminaire, the extension interface comprising:
a mounting for the modular extension unit;
a power interface for providing power to the modular extension unit; and
a communication interface for exchanging commands and data between the modular extension unit and the control circuitry of the luminaire.

22. A luminaire in accordance with claim 21, and further comprising a modular extension unit integrated with the luminaire.

23. A luminaire in accordance with claim 21, wherein the power and communication interfaces comprise contact plates for conducting power and data signals between the modular extension unit and the extension interface.

24. A luminaire in accordance with claim 21, wherein the power interface comprises a non-contact wireless power interface.

25. A luminaire in accordance with claim 24, wherein the non-contact wireless power interface includes a power transmitter coil comprising a part of a transformer when positioned proximate a corresponding coil in the modular extension unit.

26. A luminaire in accordance with claim 24, wherein the communication interface comprises power circuitry configured to superimpose a communication signal on an alternating signal applied to the non-contact wireless power interface for providing commands and data to the modular extension unit.

27. A luminaire in accordance with claim 21, comprising:
a plurality of mountings for a plurality of modular extension units;
a plurality of power interfaces for providing power to the plurality of modular extension units; and
a bus connecting a plurality of communication interfaces and for connection to the plurality of modular extension units, the bus further connected to the control circuitry of the luminaire for exchanging commands and data between the plurality of modular extension units and the control circuitry.
